(19) United States
(12) Patent Application Publication
(10) Pub. No.: US 2012/0154865 A1
(43) Pub. Date: Jun. 21, 2012

(54) PRINTING APPARATUS, CONTROL METHOD THEREFOR, AND STORAGE MEDIUM STORING CONTROL PROGRAM THEREFOR

(75) Inventor: Osamu HOSODA, Inagi-shi (JP)

(73) Assignee: CANON KABUSHIKI KAISHA, Tokyo (JP)

(21) Appl. No.: 13/329,384

(22) Filed: Dec. 19, 2011

(30) Foreign Application Priority Data
Dec. 20, 2010 (JP) 2010-283239

(51) Int. Cl. G06K 15/02

(52) U.S. Cl. 358/1.15

(57) ABSTRACT

A printing apparatus that is capable of matching orientations of images on printed sheets even for a job of which information added to a head is insufficient to specify types of all sheets. The printing apparatus prints an image on a sheet by executing a job. A determination unit determines whether a use of a tab sheet is set to information added to the head of the job. A control unit determines an orientation of an image to be printed on a non-tab sheet according to an orientation of the tab sheet included in the information when the use of the tab sheet is set. The control unit determines an orientation of an image to be printed on a non-tab sheet according to discrimination of whether the tab sheet is included in the job based on analysis of the job when the use of the tab sheet is not set.

### BACKGROUND OF THE INVENTION

1. Field of the Invention

The present invention relates to a printing apparatus, a control method therefor, and a storage medium storing a control program therefore, and particularly, relates to a printing technique for printing while changing a plurality of types of printing sheets during execution of one job.

2. Description of the Related Art

Conventionally, there were some printing apparatuses that execute a printing process using plural types of printing sheets, such as a tap sheet and a non-tab sheet like a plain sheet, for one job inputted. A tab sheet has a tab that is projected in one of long sides of a rectangular shape, and is used as a boundary of sections at the time of filing, etc. When printing on a non-tab sheet, although an orientation of an image is determined according to a setting (landscape or portrait) of a printing apparatus, an image may be formed in an orientation rotated in 180 degrees.

On the other hand, when printing on a tab sheet, since an image must be located in a predetermined position with respect to the tab, the orientation of the image is uniquely determined according to the setting (landscape or portrait) of the printing apparatus, a rotation of the image in 180 degrees is not allowed. Moreover, a post-processing device that is arranged after the printing apparatus may restrict the orientation of the tab sheet conveyed. In this case, the orientation of the tab sheet conveyed is determined based on a type of a post process executed after printing by the printing apparatus. When such a printing apparatus executes a print job using non-tab sheets and tab sheets, it is necessary to match the orientation of an image printed on the non-tab sheet with the orientation of an image printed on the tab sheet. Printing techniques that match the orientation of an image printed on the non-tab sheet with the orientation of an image printed on the tab sheet are disclosed in Japanese Laid-Open Patent Publication (Kokai) No. 2007-17704 (JP 2007-17704A) and Japanese Laid-Open Patent Publication (Kokai) No. 2007-290208 (JP 2007-290208A), for example.

A conventional printing apparatus analyzes information added to a head of a job and specifies a type of sheet and a type of a post process in order to print images in the same orientation on non-tab sheets and tab sheets.

However, not all types of printing sheets can be specified according to the information added to the head of the job. For example, there are jobs to print on continuous forms and to print records of a database as one document. When executing such jobs, it is necessary to generate jobs corresponding to the huge number of outputs, and an application that accesses the database generates jobs while sending jobs to a printing apparatus. Therefore, the information added to the head of job is insufficient to specify the types of all the sheets to be printed.

Thus, when processing the job of which the information added to the head is insufficient to specify the types of all the sheets to be printed, a post-process, etc., there is a possibility that an orientation of an image that is outputted to a non-tab sheet in advance is different from an orientation of an image that is outputted to a tab sheet later, for example.

### SUMMARY OF THE INVENTION

The present invention provides a technique that is capable of matching orientations of images on printed sheets even for a job of which information added to a head is insufficient to specify types of all sheets to be printed, a post-process, etc.

Accordingly, a first aspect of the present invention provides a printing apparatus that prints an image on a sheet by executing a job comprising a determination unit configured to determine whether a use of a tab sheet is set to information added to the head of the job, and a control unit configured to determine an orientation of an image to be printed on a sheet other than the tab sheet according to an orientation of the tab sheet included in the information when the determination unit determines that the use of the tab sheet is set, and to determine an orientation of an image to be printed on a sheet other than the tab sheet according to discrimination of whether the tab sheet is included in the sheets to be printed by executing the job based on analysis of the job when the determination unit determines that the use of the tab sheet is not set.

Accordingly, a second aspect of the present invention provides a control method for a printing apparatus that prints an image on a sheet by executing a job, the control method comprising a determination step of determining whether a use of a tab sheet is set to information added to the head of the job, and a control step of determining an orientation of an image to be printed on a sheet other than the tab sheet according to an orientation of the tab sheet included in the information when determining that the use of the tab sheet is set in the determination step, and determining an orientation of an image to be printed on a sheet other than the tab sheet according to discrimination of whether the tab sheet is included in the sheets to be printed by executing the job based on analysis of the job when determining that the use of the tab sheet is not set in the determination step.

Accordingly, a third aspect of the present invention provides a non-transitory computer-readable storage medium storing a control program causing a computer to execute the control method of the second aspect.

Accordingly, a fourth aspect of the present invention provides a printing apparatus that prints an image on a sheet by executing a job comprising a determination unit configured to determine whether job information showing a setting of a job is added to the head of the job, and a control unit configured to determine an orientation of an image to be printed on a sheet other than the tab sheet according to an orientation of the tab sheet included in the job information when the determination unit determines that the job information is added, and to determine an orientation of an image to be printed on a sheet other than the tab sheet according to discrimination of whether the tab sheet is included in the sheets to be printed by executing the job based on analysis of the job when the determination unit determines that the job information is not added.

According to the present invention, the orientations of the images on the printed sheets can be matched even for a job of which information added to a head is insufficient to specify types of all sheets to be printed, a post-process, etc.

Further features of the present invention will become apparent from the following description of exemplary embodiments with reference to the attached drawings.

### BRIEF DESCRIPTION OF THE DRAWINGS

FIG. 1 is a view showing an entire configuration of a printing system including a printing apparatus according to a first embodiment of the present invention.

FIG. 2 is a view schematically showing an internal configuration of a printer body (a main unit of the printing apparatus) in FIG. 1.

FIG. 3 is a view schematically showing an internal configuration of a post-processing device connectable with the printer body in FIG. 2.

FIG. 4 is a view schematically showing an internal configuration of a mass ejection device connectable with the printer body in FIG. 2.

FIG. 5 is a view schematically showing an internal configuration of a feeding device connectable with the printer body in FIG. 2.

FIG. 6 is a block diagram schematically showing a functional configuration of the printer body in FIG. 2.

FIG. 7A is a view for describing a sheet conveyance method in the case of ejecting a sheet printed by the printer body in FIG. 2 to the post-processing device.

FIG. 7B is a view for describing a sheet conveyance method in the case of ejecting a sheet printed by the printer body in FIG. 2 to the mass ejection device.

FIG. 8A is a view showing an example of a data structure of a job in which a use of a tab sheet is set at the head of the job.

FIG. 8B is a view showing an example of a data structure of a job in which a use of a tab sheet is not set at the head of the job.

FIG. 9 is a view showing a relation between an ejecting destination and a page number when printing a second format job shown in FIG. 8B.

FIG. 10 is a view showing orientations of images on sheets ejected to the post-processing device and the mass discharge device, when the printing system in FIG. 1 executes a printing process for the second format job.

FIG. 11 is a flowchart showing procedures of a process that the printing apparatus of the first embodiment generates image data based on a received job and stores it into an HDD.

FIG. 12 is a flowchart showing procedures of a process that transmits the image data generated in step S1405 in FIG. 11 to an image forming unit to print.

FIG. 13 is a flowchart showing procedures of a process that the printing apparatus of a second embodiment generates image data based on a received job and transmits it to an image forming unit to print.

FIG. 14 is a view showing an example of a data structure of a job that is divided into a plurality of blocks.

FIG. 15 is a flowchart showing procedures of a process that the printing apparatus of a third embodiment generates image data based on a received job and stores it into an HDD.

### DESCRIPTION OF THE EMBODIMENTS

Hereafter, embodiments according to the present invention will be described in detail with reference to the drawings.

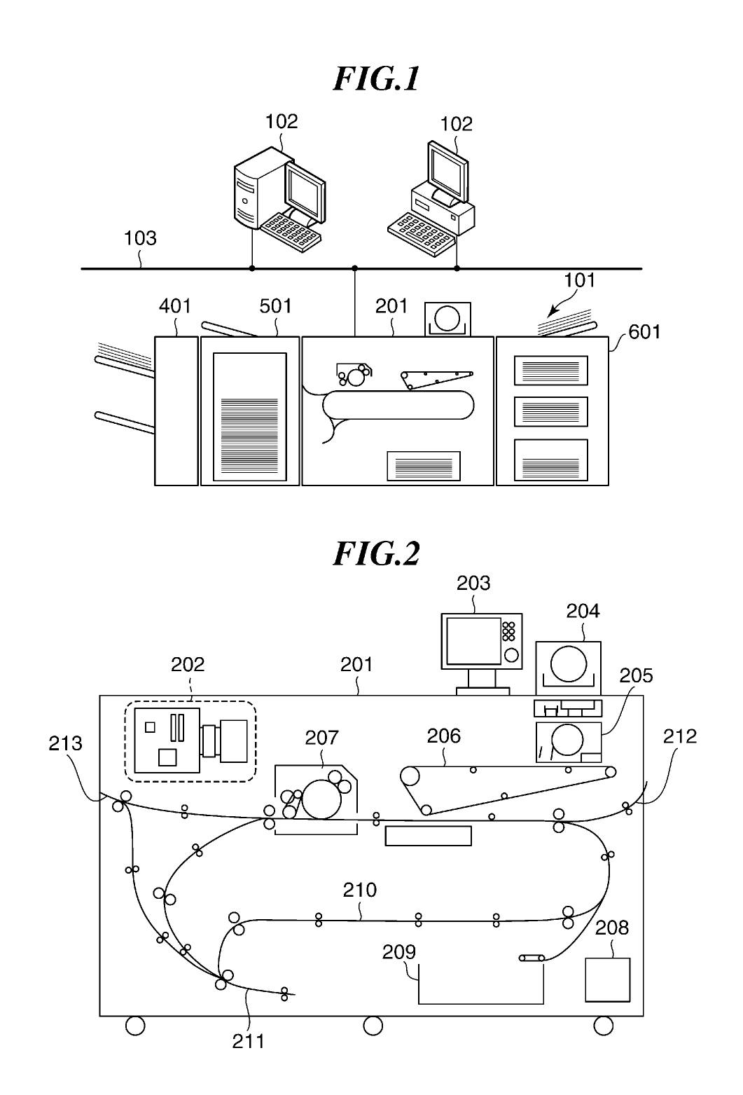

FIG. 1 is a view showing an entire configuration of a printing system including a printing apparatus according to a first embodiment of the present invention.

As shown in FIG. 1, the printing apparatus 101 is connected to a plurality of host computers 102 via a network 103 like a LAN (Local Area Network), and communicates with these computers. The host computers 102 are provided with a function for transmitting printing data (a job) to the printing apparatus 101, and a function for editing image data by executing an image processing application. The printing apparatus 101 forms an image using the job received from the host computer 102.

The printing apparatus 101 comprises a printer body (a main unit of the printing apparatus) 201, a sheet feeding device 601, a mass ejection device 501, and a post-processing device 401. These devices are connected so that a sheet passes through the devices by connecting an exit of an upstream device to an entrance of a downstream device. Although this embodiment describes the sheet feeding device 601, the mass ejection device 501, and the post-processing device 401, other devices may be connected to the printer body.

FIG. 2 is a view schematically showing an internal configuration of the printer body 201 in FIG. 1.

As shown in FIG. 2, the printer body 201 is provided with a control unit 202 that operates software for various controls of the printing apparatus 101, an operation unit 203 through which a user instructs operation to the printing apparatus 101, a toner supplying unit 204 that supplies toner (printing agent), a fixing unit 207 that fixes a transferred image onto a sheet, a surplus toner collection unit 208 that collects surplus toner, and a sheet feeding unit 209 that supplies a sheet to the image forming unit 205. The toner supplying unit 204 is equipped with a shut-off door, and an operator is able to supply toner while opening the shut-off door.

The image forming unit 205 forms an image instructed by the job using the toner supplied from the toner supplying unit 204, and transfers it onto an intermediate transfer belt 206. The image transferred to the intermediate transfer belt 206 is transferred to a sheet. It should be noted that a sheet in this embodiment includes special sheets such as a tab sheet in addition to a plain sheet.

The fixing unit 207 fixes the toner to the sheet by applying heat and pressure to the sheet on which the image has been transferred from the intermediate transfer belt 206. The surplus toner that has not been transferred to the sheet on the intermediate transfer belt 206 is stored in the surplus toner collection unit 208.

The sheet that has been supplied from the sheet feeding unit 209 in the printing apparatus is conveyed through a sheet conveyance unit 210, and the toner transferring process and a fixing process are applied. The printer body 201 is equipped with a switchback section 211 for reversing a sheet, a sheet entrance slot 212 for inputting a sheet from an external sheet feeding device, and an ejection unit 213 for ejecting a sheet to which the fixing process has been applied to an external post-processing device.

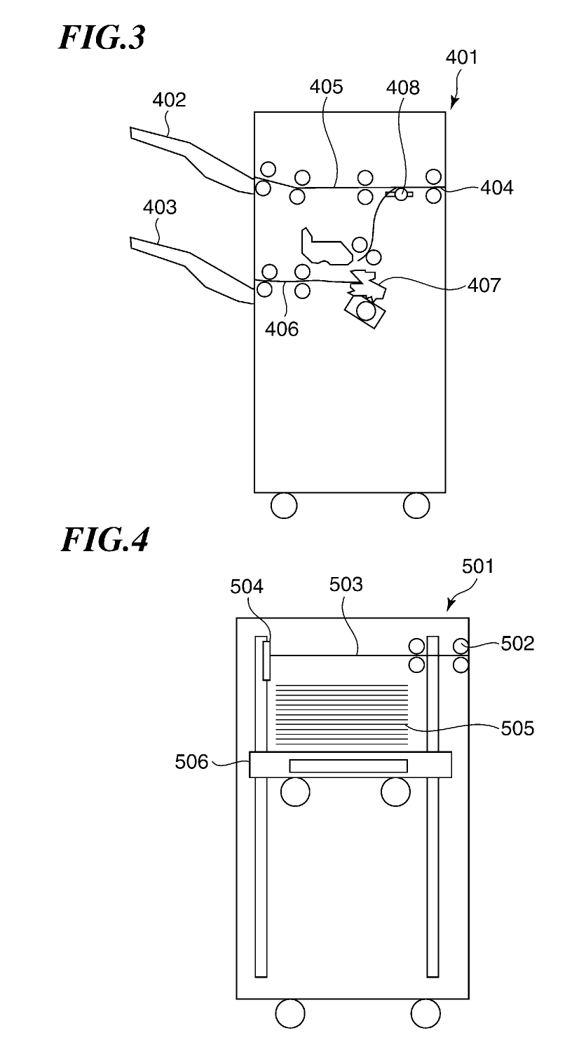

FIG. 3 is a view schematically showing an internal configuration of the post-processing device 401 connectable with the downstream of the mass ejection device 501. It should be noted that the post-processing device 401 is directly connectable with the printer body 201.

As shown in FIG. 3, the post-processing device 401 is provided with a first sheet ejection unit 402 on which the ejected sheets are stacked, a second sheet ejection unit 403, and a sheet entrance 404 to which a sheet is supplied from the device connected to the upstream of the post-processing device 401.

The post-processing device 401 is further provided with a first conveyance path 405 for ejecting a sheet to the first sheet ejection unit 402, a second conveyance path 406 for ejecting a sheet to the second sheet ejection unit 403, a staple unit 407 for performing a staple process to a sheet ejected to the second sheet ejection unit 403, and a conveyance path change mechanism 408. The conveyance path change mechanism 408 changes the conveyance path of a sheet inputted from the sheet entrance 404 so that the sheet is selectably guided to the first conveyance path 405 or the second conveyance path 406.

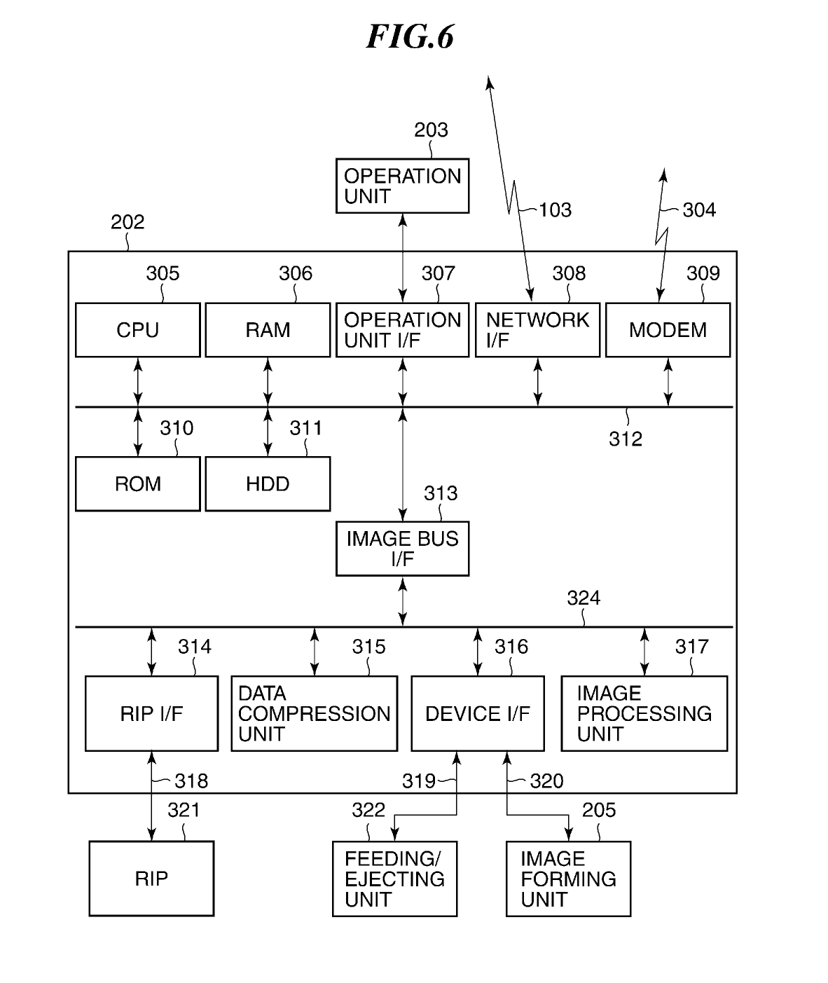

The conveyance path of the sheet inputted from the sheet entrance 404 is changed by the conveyance path change mechanism 408 according to a command from the control unit 202 (see FIG. 6) in the printer body 201 so that the sheet is conveyed to the first conveyance path 405 or the second conveyance path 406. The sheet conveyed to the first conveyance path 405 is ejected to the first sheet ejection unit 402. On the other hand, the sheet conveyed to the second conveyance path 406 is stored so that the end of the sheet contacts the staple unit 407. When the sheets for a bundle to be stapled are stored, the staple unit 407 performs the staple process to the bundle of the sheets, and the stapled sheet bundle is ejected to the second sheet ejection unit 403. That is, the staple unit 407 binds the rear edge in the conveyance direction of the sheet.

A rear edge in the conveyance direction of a sheet ejected to the first sheet ejection unit 402 or the second paper ejection unit 403 needs to be linear. Therefore, a tab of a tab sheet must not be positioned at the rear edge in the conveyance direction.

Although the post-processing device 401 is connected to the printer body 201 via the mass ejection device 501 in FIG. 1, the arrangements of devices are not limited to the illustrated example.

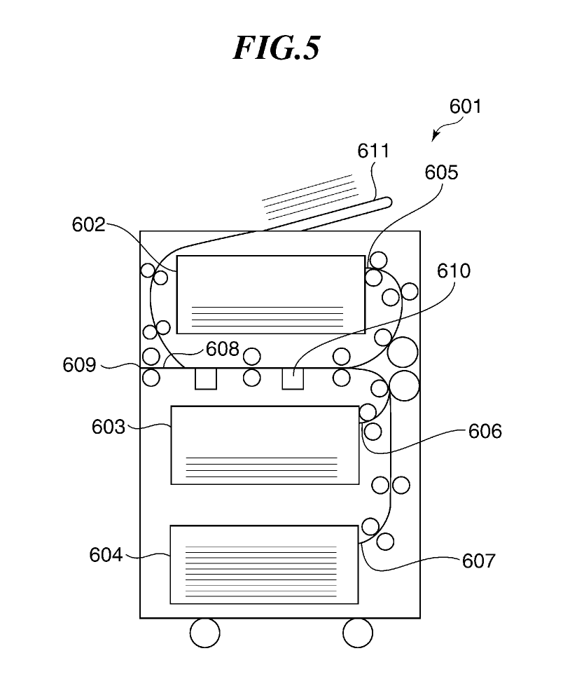

FIG. 4 is a view schematically showing an internal configuration of the mass ejection device 501 connectable with the downstream of the printer body 201 in FIG. 2.

As shown in FIG. 4, the mass ejection device 501 is provided with a sheet entrance 502 to which a sheet is supplied from the unit connected to the upstream and a conveyance path 503 for conveying the sheet supplied through the sheet entrance 502.

The mass ejection device 501 is further provided with a stopper plate 504 for stopping the conveyance of the sheet conveyed on the conveyance path 503, a sheet storage 505 for holding the sheet stopped by the stopper plate 504, and a carrying unit 506 for carrying the sheets stored in the sheet storage 505 to the outside of the mass ejection device 501. The side of the sheet that knocks against the stopper plate 504 needs to be linear. Therefore, a tab of a tab sheet must not be positioned at the front edge of the sheet in the conveyance direction.

Since the carrying device 506 is equipped with tires and a handle, a user is able to carry the printed sheets easily.

FIG. 5 is a view schematically showing an internal configuration of the sheet feeding device 601 connectable with the upstream of the printer body 201 in FIG. 2.

As shown in FIG. 5, the sheet feeding device 601 is provided with a first sheet container 602, a second sheet container 603, a third sheet container 604, an exit 605 that pulls out a sheet from the first sheet container 602 to a conveyance path, an exit 606 that pulls out a sheet from the second sheet container 603 to the conveyance path, and an exit 607 that pulls out a sheet from the third sheet container 604 to the conveyance path.

The sheet feeding device 601 is further provided with a sheet conveyance path 608 for conveying the sheets pulled out from the first, second, and third sheet containers 602, 603, and 604, an exit 609 through which the sheet conveyed on the sheet conveyance path 608 is ejected to the outside of the sheet feeding device 601, a sensor 610 for detecting whether multi feeding occurs on the sheet conveyance path 608, and a multi feeding ejection tray 611 to which multi feeding sheets are ejected when the sensor 610 detects the occurrence of the multi feeding.

It should be noted that the sheet feeding device 601 may have a function to determine a direction of a tab of a tab sheet stored in the first, second, and third sheet containers 602, 603, and 604.

FIG. 6 is a block diagram schematically showing a functional configuration of the printer body 201 in FIG. 2.

The control unit 202 is provided with a CPU 305, a RAM 306, an operation unit interface (I/F) 307, a network I/F 308, a modem 309, a ROM 310, and a hard disk drive (HDD) 311, and these components are connected via a CPU bus 312. The CPU 305 executes a program for controlling the printer body 201. The RAM 306 is controlled by the program running on the CPU, and is used as a receiving buffer for storing data received from the outside temporarily or an image data buffer for storing image data rasterized by a RIP (raster image processor) 321 temporarily, etc. The operation unit I/F 307 connects the operation unit 203 with the control unit 202. The network I/F 308 connects the control unit 202 to the network 103. The modem 309 connects the control unit 202 to a telephone line 304.

The ROM 310 stores a program running on the CPU 305 and data. The HDD 311 is a nonvolatile storage unit that can save various data in the long term. The control unit 202 is further provided with an image bus 324 connected to a hardware group for performing the image processing, and an image bus I/F 313 for connecting the CPU bus 312 to the image bus 324.

An RIP I/F 314, a data compression unit 315, a device I/F 316, and an image processing unit 317 are connected to the image bus 324. The RIP I/F 314 connects the image bus 324 with the raster image processor (RIP) 321 through an image transfer bus 318. The data compression unit 315 compresses data. The device I/F 316 connects the image forming unit 205 and a feeding/ejecting unit 322 to the image bus 324 via a data buses 319 and 320. The image processing unit 317 applies various types of image processes to bitmap format image data generated by the RIP 321. The image processing unit 317 is provided with a function for processing the bitmap image data in digital including a function for composing two-page bitmap format image data into one-page bitmap format image data.

The RIP 321 is a rasterizing board that has a function for converting image data included in a job inputted from the outside into bitmap format image data. The feeding/ejecting unit 322 includes the sheet feeding unit 209, the sheet conveyance unit 210, the switchback section 211, the sheet entrance slot 212, the ejection unit 213, etc. shown in FIG. 2.

The CPU 305 controls the image forming unit 205 and the feeding/ejecting unit 322 via the data buses 319 and 320 to execute a predetermined printing process according to signals instructed from the operation unit 203 or an external apparatus via the network 103.

Next, a sheet conveyance method in the printing apparatus 101 in FIG. 1 will be described.

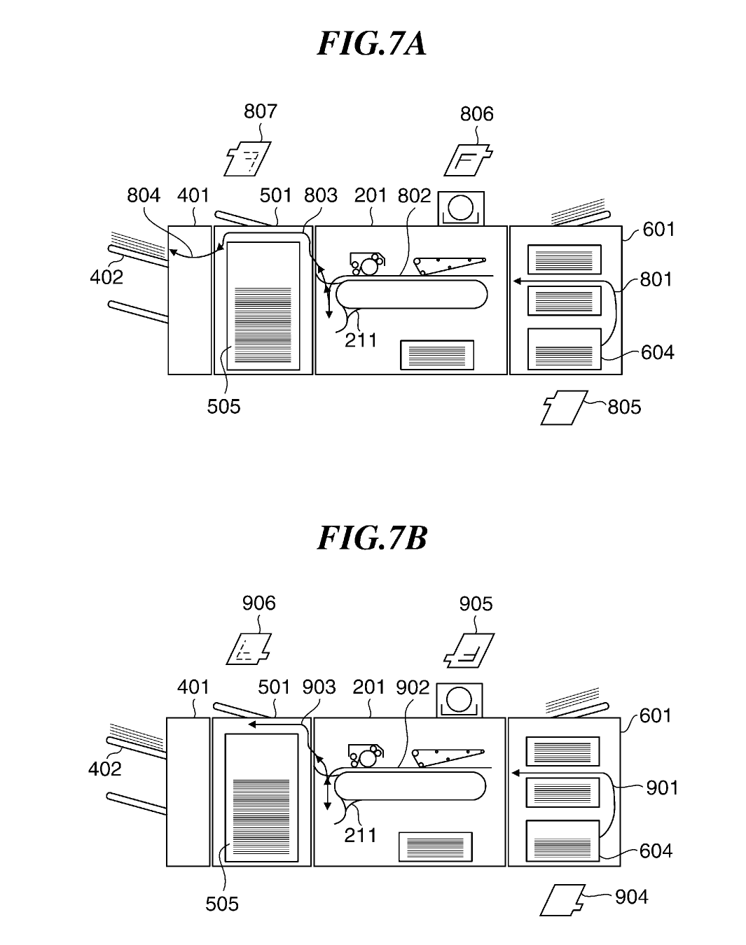

FIG. 7A is a view for describing the sheet conveyance method in the case of ejecting a sheet printed by the printer body 201 to the post-processing device 401. FIG. 7B is a view for describing the sheet conveyance method in the case of ejecting a sheet printed by the printer body 201 to the mass ejection device 501.

As shown in FIG. 7A, the sheet contained in the third sheet container 604 in the sheet feeding device 601 is conveyed along the conveyance path 801, and is sent to the printer body 201. The printer body 201 prints an image on a front side of the sheet entered therein while being conveyed along the conveyance path 802. And then, the printed sheet is turned upside down by the switchback section 211, and is ejected to the mass ejection device 501. The sheet entered in the mass ejection device 501 is conveyed along the conveyance path 803. The mass ejection device 501 passes the sheet without performing any process. The sheet that passed the mass ejection device 501 enters into the post-processing device 401, and is conveyed along the conveyance path 804.

The case where a tab sheet is conveyed along the above-mentioned conveyance paths will be described. The tab sheet contained in the third sheet container 604 in the sheet feeding device 601 is set in the orientation shown by a reference numeral 805. A tab sheet has a tab formed to be projected from one long side of a rectangular sheet. When executing the job for conveying the tab sheet contained in the third sheet container 604 in the sheet feeding device 601 to the post-processing device 401, a user stores the tab sheet so that the tab is positioned at a rear edge with respect to the sheet conveyance direction. This enables to staple the tab sheet normally. The reason will be described. When stapling the tab sheet, the side opposite to the tab is bound. When binding the side opposite to the tab of the tab sheet, the tab sheet must be conveyed so that the side opposite to the tab of the tab sheet contacts the staple unit 407. As shown in FIG. 3, the sheets conveyed to the post-processing device 401 are stacked on the second conveyance path 406, and the rear edges of the stacked sheets in the conveyance direction are bound by the staple unit 407. Therefore, the tab needs to be located at the front edge in the conveyance direction at the time when the tab sheet enters into the post-processing device 401. When the sheets are sequentially outputted from the first page facedown, the printed tab sheet is inverted by the switchback part 211 and is ejected. Therefore, a user should store the tab sheet so that the tab is positioned at the rear edge with respect to the sheet conveyance direction as shown in FIG. 7A in order to bind the side opposite to the tab of the tab sheet by the staple unit 407.

Even when not stapling, the tab sheet and the non-tab sheet that are ejected to the first sheet ejection unit 402 or the second sheet ejection unit 403 can be aligned by conveying the tab sheet to the post-processing device 401 by the method shown in FIG. 7A. It's because when the tab sheet is ejected to the first sheet ejection unit 402 or the second sheet ejection unit 403 so that the tab is located at the rear edge, the ejected tab sheet is stacked while being supported by the body side of the post-processing device 401 by self-weight. At this time, if the tab of the tab sheet is located at the body side of the post-processing device 401, the projected tab displaces the tab sheet from the non-tab sheet. Therefore, the tab sheet and the non-tab sheet can be stacked and aligned by ejecting the tab sheet to the first sheet ejection unit 402 or the second sheet ejection unit 403 so that the side opposite to the tab of the tab sheet comes to the body side of the post-processing-device 401.

A reference numeral 806 in FIG. 7A shows the orientation of the tab sheet on which an image is printed in the printer body 201 with respect to the sheet conveyance direction. A reference numeral 807 shows the orientation of the tab sheet ejected to the first sheet ejection unit 402 of the post-processing device 401. The tab sheet ejected to the first sheet ejection unit 402 is conveyed so that the image printed side faces down and that the tab of the tab sheet is positioned at the front edge with respect to the sheet conveyance direction.

As shown in FIG. 7B, the sheet contained in the third sheet container 604 in the sheet feeding device 601 is conveyed along the conveyance path 901, and is sent to the printer body 201. The printer body 201 prints an image on a front side of the sheet entered therein while being conveyed along the conveyance path 902. And then, the printed sheet is turned upside down by the switchback section 211, and is ejected to the mass ejection device 501. The sheet entered in the mass ejection device 501 is conveyed along the conveyance path 903, and is stored to the sheet storage 505.

The case where a tab sheet is conveyed along the above-mentioned conveyance paths will be described. The tab sheet contained in the third sheet container 604 in the sheet feeding device 601 is set in the orientation shown by a reference numeral 904. When executing the job for ejecting the tab sheet contained in the third sheet container 604 in the sheet feeding device 601 to the mass ejection device 501, a user stores the tab sheet so that the tab is positioned at the front edge with respect to the sheet conveyance direction. This enables to stack the tab sheet on the mass ejection device 501 normally. It's because the tab sheet needs to be stacked by knocking the side that does not include the tab of the tab sheet against the stopper plate 504 shown in FIG. 4. When the tab knocks against the stopper plate, the projected tab may displace the tab sheet stacked on the carrying unit 506 from the non-tab sheet. In order to prevent such a displacement, it is necessary to stack the tab sheet by knocking the side that does not include the tab of the tab sheet against the stopper plate 504. When the sheets are sequentially outputted from the first page facedown, the printed tab sheet is inverted by the switchback part 211 and is ejected. At this time, a user should store the tab sheet so that the tab is directed frontward in the sheet conveyance direction as shown in FIG. 7B in order to stack the tab sheet by knocking the side opposite to the tab of the tab sheet against the stopper plate 504.

A reference numeral 905 in FIG. 7B shows the orientation of the tab sheet on which an image is printed in the printer body 201 with respect to the sheet conveyance direction. A reference numeral 906 shows the orientation of the tab sheet stored in the sheet storage 505 in the mass ejection device 501. The tab sheet stored in the sheet storage 505 is conveyed so that the image printed side faces down and that the tab is positioned at the rear edge with respect to the sheet conveyance direction.

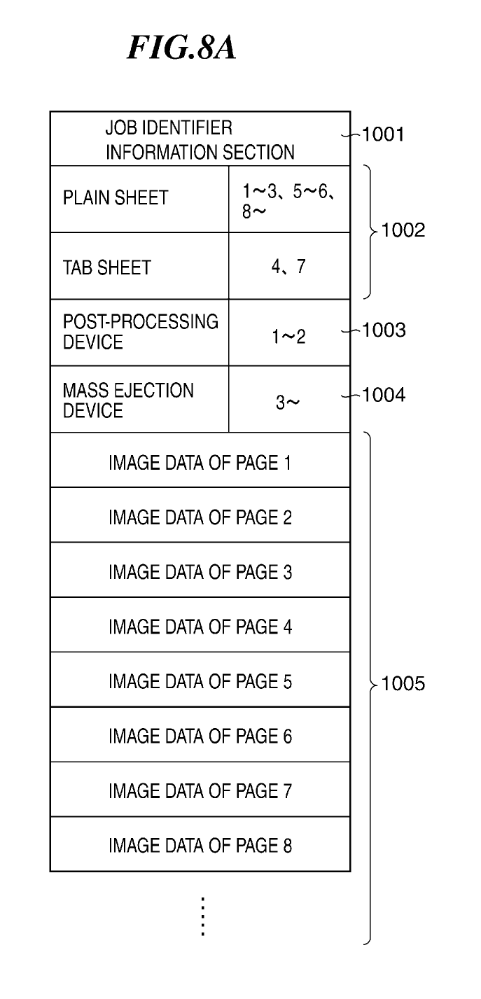

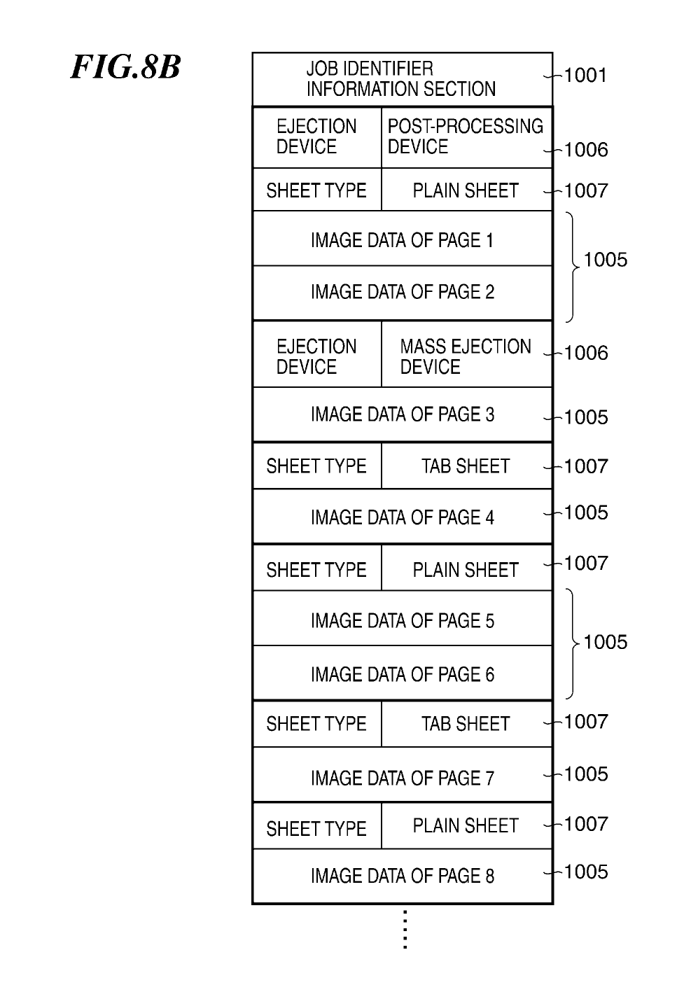

Next, a structure of a job inputted into the printing apparatus 101 will be described. The printing apparatus 101 executes plural types of jobs. FIG. 8A and FIG. 8B show examples of jobs of different types, respectively. The CPU 305 of the printing apparatus 101 interprets these jobs sequentially from the head.

FIG. 8A is a view showing an example of a data structure of a job in which a use of a tab sheet is set at the head of the job. FIG. 8B is a view showing an example of a data structure of a job in which a use of a tab sheet is set at the middle rather than the head of the job. It should be noted that the job with the data structure shown in FIG. 8A is referred to as a first format job and the job with the data structure shown in FIG. 8B is referred to as a second format job in the following description.

The first format job shown in FIG. 8A includes a job identifier information section 1001 in which a name and ID information of a job are stored, a sheet designation section 1002 in which the type of printing sheet is defined per page, a post-process specification section 1003 in which the page ejected to the post-processing device 401 is designated, an ejecting destination specification section 1004 in which a page ejected to the mass ejection device 501 is designated, and an image data storage section 1005 in which image data is stored per page.

The second format job shown in FIG. 8B includes a setting for changing the type of sheet and a setting for switching the post process during the job. For example, the second format job includes an ejecting destination change designation section 1006 in which a change of the ejecting destination is designated and a sheet change designation section 1007 in which a change of the type of printing sheet is designated, in addition to the sections 1001 and 1005 similar to that in the first format job.

When executing the first format job shown in FIG. 8A, the printing apparatus 101 can specify whether the tab sheet is used and whether the tab sheet will be ejected to the post-processing device 401 or the mass ejection device 501, according to the information added to the head of the job before starting a print. On the other hand, when executing the second format job shown in FIG. 8B, the printing apparatus 101 cannot specify the information about the tab sheet and the post process until finishing interpreting the ejecting destination change designation section 1006 and the sheet change designation section 1007 included in the job. If the second format job shown in FIG. 8B is executed before finishing interpreting the ejecting destination change designation section 1006 and the sheet change designation section 1007 included in the job, the orientation of the image printed on the non-tab sheet may differ from the orientation of the image printed on the tab sheet. Such a situation will be described below.

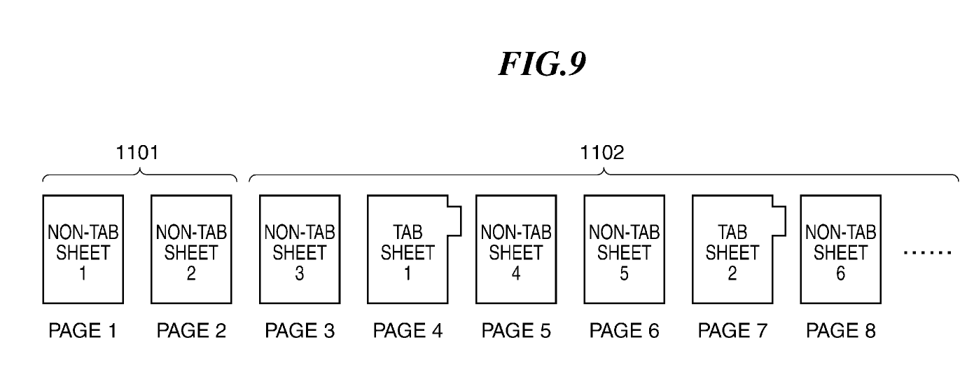

FIG. 9 is a view showing a relation between an ejecting destination and a page number when printing a second format job shown in FIG. 8B.

A group 1101 of sheets ejected to the post-processing device 401 includes the pages 1 and 2 of non-tab sheets. A group 1102 of sheets ejected to the mass ejection device 501 includes the pages 3, 5, 6, and 8 of non-tab sheets and the pages 4 and 7 of tab sheets. It should be noted that the numerals described under the labels of “tab sheet” and “non-tab sheet” in FIG. 9 are the numbers of the tab sheets and the non-tab sheets, respectively. It should be noted that this embodiment describes a non-tab sheet as a plain sheet or a regular sheet.

If the conventional printing system executes the print process for the second format job shown in FIG. 8B, an image corresponding to the image data of the page 1 is formed after completing the interpretation of the ejecting designation change designation section 1006 of the first occurrence and the sheet change designation section 1007 and developing the image data of the page 1. Then, the image corresponding to the image data of the page 2 is formed when the image data of the page 2 is developed.

Then, the conventional printing system recognizes that the ejection device is changed from the post-processing device to the mass ejection device, and the image corresponding to the image data of the page 3 is formed when the image data of the page 3 is developed. Next, the conventional printing system recognizes that the image corresponding to the image data of the page 4 is designated to be printed on the tab sheet before interpreting the image data of the page 4. Here, since the conveyance direction of the tab sheet ejected to the mass loading device and the orientation of the image printed on the tab sheet are determined uniquely, the conventional printing system cannot print the image corresponding to the image data of the page 4 in the same orientation as the image corresponding to the image data of the page 3.

Therefore, if the conventional printing system executes the print process for the second format job shown in FIG. 8B, the pages 4 and 7 of the tab sheets are ejected so that the orientation of the images thereon is different from the orientation of the images on the other pages of the non-tab sheets.

Therefore, when executing the print process for the second format job, the printing system of this embodiment controls so as to execute a post-RIP printing that starts printing when the interpretation of the job and the development of the image data are completed. Then, when determining that the tab sheet is included, the printing system determines the orientation of the image printed on the tab sheet according to whether the tab sheet will be conveyed to the post-processing device 401 or the mass loading device 501. The printing system rotates the image printed on the non-tab sheet that will be ejected to the device to which the tab sheet will be ejected so that the orientation of the image printed on the non-tab sheet matches the orientation of the image printed on the tab sheet among the pages included in the job.

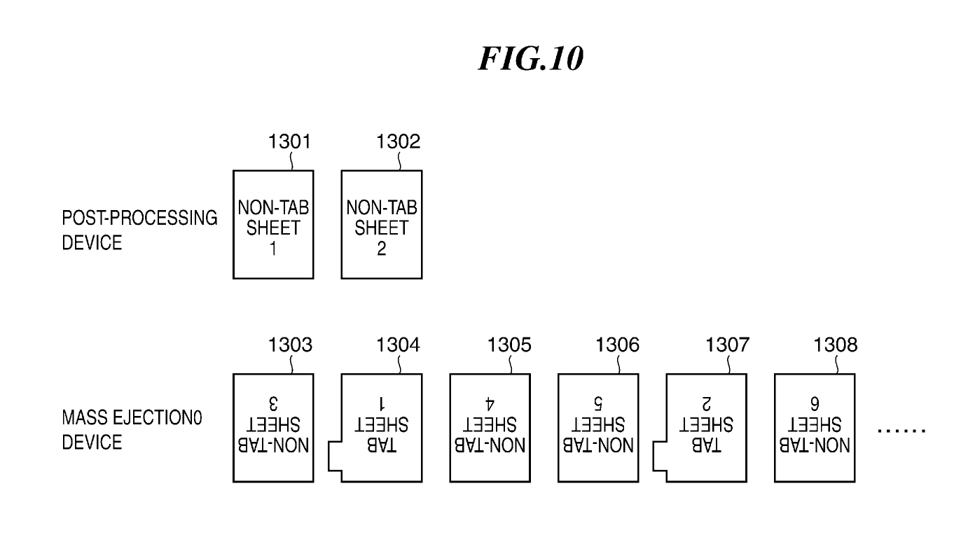

FIG. 10 is a view showing orientations of images on sheets ejected to the post-processing device 401 and the mass ejection device 501, when the printing system of this embodiment executes the printing process for the second format job shown in FIG. 8B.

As shown in FIG. 10, the sheets 1301 and 1302 are ejected to the post-processing device 401. The sheets 1303 through 1308 are ejected to the mass ejection device 501.

When the printing apparatus 101 in this embodiment executes the printing process for the second format job shown in FIG. 8B, the tab sheets 1304 and 1307 are ejected so that the orientation of the images thereon matches the orientation of the images on the non-tab sheets 1303, 1305, etc.

As a result, a user does not need to rearrange the sheets so that the orientation of the image on every sheet becomes identical.

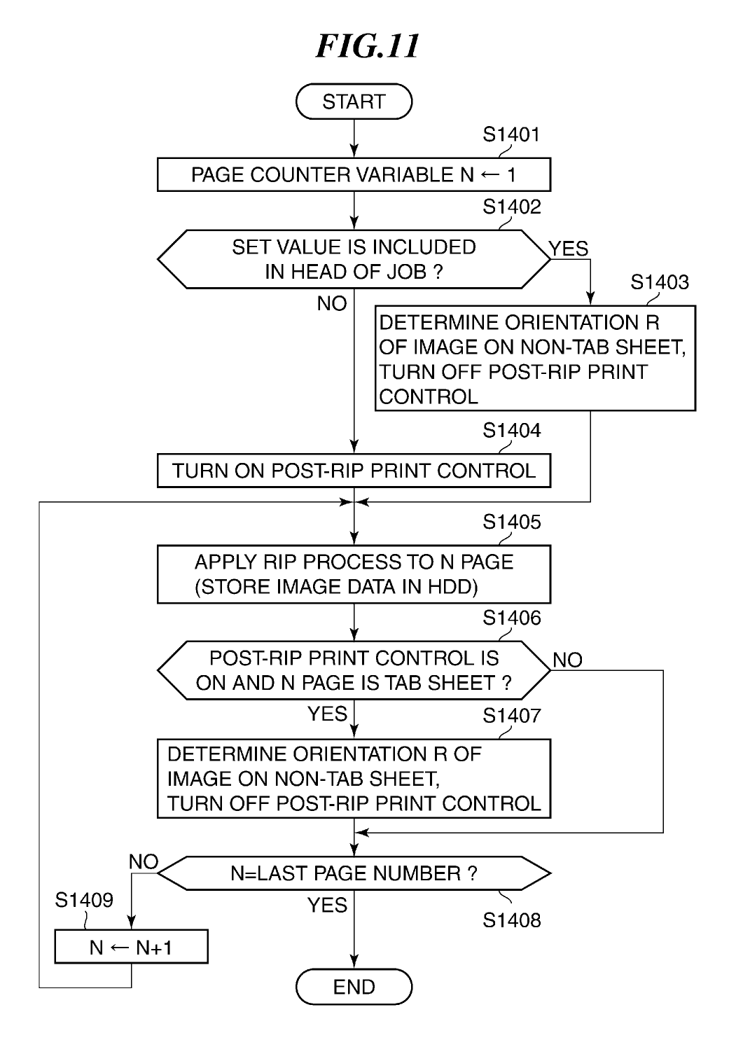

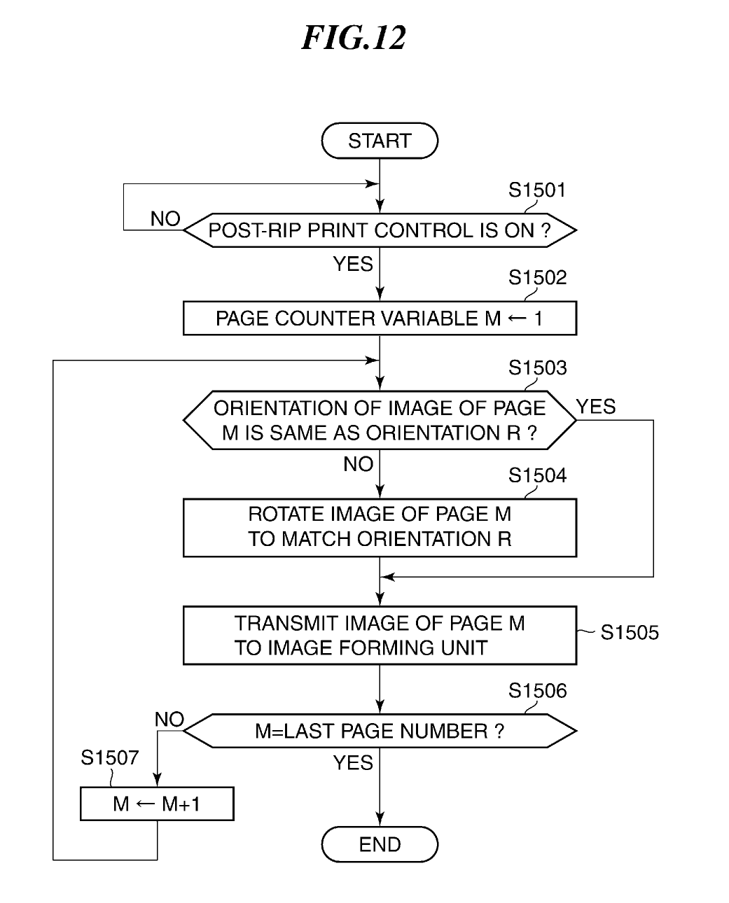

Next, the printing process for the second format job shown in FIG. 8B in the printer body 201 will be described using flowcharts in FIG. 11 and FIG. 12. It should be noted that the program for executing the printing process is stored in the HDD 311 etc., is read to the RAM 306, and is executed by the CPU 305. The programs for executing the control of the image formation in this embodiment include a control program for executing a post-RIP print control that executes the printing process by the image forming unit 205 after generating the entire image data included in the job.

FIG. 11 is a flowchart showing procedures of a process to analyze a received job, to generate image data by the RIP 321, and to store the generated image data to the HDD 311 in the printing apparatus 101 of the first embodiment.

When an analysis process for the received job is started, the CPU 305 initializes a page counter variable N in step S1401 (N←1), and proceeds with the process to step S1402.

In the step S1402, the CPU 305 determines whether a use of a special sheet (a tab sheet, here) is set in the information added to the head of the job. In this step, the CPU 305 determines whether the received job is the first format job or the second format job. The CPU 305 functions as a determination unit here.

When the CPU 305 determines that the use of the spatial sheet is set in the information added to the head of the job in the step S1402, i.e., when the CPU 305 determines that the job is the first format job, the process proceeds to step S1403. If not, i.e., the CPU 305 determines that the job is the second format job, the process proceeds to step S1404.

In the step S1403, the CPU 305 determines an orientation R of an image that will be printed on a non-tab sheet (a non-special sheet) based on a combination of the type of sheet and a post process that are set in the job. The CPU 305 functions as a control unit here. That is, the CPU 305 focuses on the special sheet like the tab sheet of which the conveyance direction is uniquely determined according to the combination with the post process, among the types of the sheets designated in the sheet designation section 1002 of the job. Then, the CPU 305 determines the orientation of the image printed on the special sheet as the orientation R of the image printed on the non-tab sheet. It should be noted that the tab sheet shall be designated as an example of the special sheet in this embodiment.

In the step S1403, the CPU 305 turns OFF the post-RIP print control that is a control method of image formation, and proceeds with the process to step S1405.

On the other hand, in the step S1404, the CPU 305 turns ON the post-RIP print control that is a control method of image formation, and proceeds with the process to the step S1405.

In the step S1405, the CPU 305 instructs the RIP 321 to perform the RIP process for the image data of the page corresponding to the page counter variable N, generates image data, and stores the generated image data in the HDD 311. The CPU 305 and the RIP 321 function as an image data generation unit here.

In step S1406, the CPU 305 determines whether the post-RIP print control is ON and the page of the page counter variable N is the tab sheet. The CPU 305 functions as a sheet determination unit here. When the CPU 305 determines that the post-RIP print control is OFF or the page of the page counter variable N is the non-tab sheet in the step S1406, the process proceeds to step S1408. On the other hand, when the CPU 305 determines that the post-RIP print control is ON and the page of the page counter variable N is the tab sheet, the process proceeds to step S1407.

In the step S1407, the CPU 305 determines the post process or the ejecting destination designated for the page of the page counter variable N, and determines the orientation R of the image to be printed on the non-tab sheet based on the combination with the tab sheet. The CPU 305 functions as the control unit here.

In the step S1408, the CPU 305 determines whether the page counter variable N points the last page of the job. When the CPU 305 determines that the page counter variable N points the last page of the job, this process is finished. On the other hand, when it is determined that the page counter variable N does not points the last page of the job, the process proceeds to step S1409.

In the step S1409, the CPU 305 increments the page counter variable N, and proceeds with the process to step S1405 to execute the process in the steps S1405 through S1408 repeatedly.

FIG. 12 is a flowchart showing procedures of a process that transmits the image data generated in the step S1405 in FIG. 11 to the image forming unit 205 to print.

In step S1501, the CPU 305 monitors whether the post-RIP print control is set as ON. When the CPU 305 determines that the post-RIP print control is set as ON in the step S1501, the process proceeds to step S1502.

In the step S1502, the CPU 305 initializes a page counter variable M for printing (M←1), and proceeds with the process to step S1503.

In the step S1503, the CPU 305 determines whether the orientation of the image of the page corresponding to the page counter variable M is the same as the orientation R of the image determined in the step S1403 or S1407 in FIG. 11. As a result of this determination, when the CPU 305 determines that the orientation of the image of the page corresponding to the page counter variable M is the same as the orientation R of the image, the process proceeds to step S1505. On the other hand, when the CPU 305 determines that the orientation of the image of the page corresponding to the page counter variable M differs from the orientation R of the image, the process proceeds to step S1504.

In the step S1504, the CPU 305 executes a process for rotating the image of the page corresponding to the page counter variable M so that the orientation thereof matches the orientation R of the image by controlling the image processing unit 317. At this time, the CPU 305 and the image processing unit 317 function as an image rotation unit.

In the step S1505, the CPU 305 transmits the image data of the page corresponding to the page counter variable M to the image forming unit 205. Then, the sheet is conveyed to the designated post-processing device or is ejected to the designated ejecting destination based on the post process and the ejecting destination that are set in the job.

In step S1506, the CPU 305 determines whether the page counter variable M points the last page of the job. When the CPU 305 determines that the page counter variable M points the last page of the job, this process is finished. On the other hand, when it is determined that the page counter variable M does not points the last page of the job, the process proceeds to step S1507.

In the step S1507, the CPU 305 increments the page counter variable M, and proceeds with the process to step S1503 to execute the process in the steps S1503 through S1506 repeatedly.

According to this embodiment, even if the special sheet (the tab sheet) of which the conveyance direction in the apparatus is uniquely determined according to the post process and the ejecting destination is mixed with the non-special sheet (the non-tab sheet) in a job, images can be printed without generating a mismatch of the orientations of the images among pages.

Even if a use of the special sheet is set in the middle of a job, it becomes possible to match the orientation of the image on the special sheet with that on the non-special sheet. When a job does not include the special sheet, images can be printed in the same orientation in the same manner as the conventional system.

Although the above-mentioned first embodiment describes the printing apparatus that is equipped with the mass storage unit like the HDD 311, there is a printing apparatus that is not equipped with the mass storage unit. So, a second embodiment describes the printing process in the printing apparatus 101 that omits the HDD 311 from the control unit 202 in the printing apparatus 101 shown in FIG. 6. The same reference numbers are attached to the same elements as that in the first embodiment, and the duplicated descriptions are omitted.

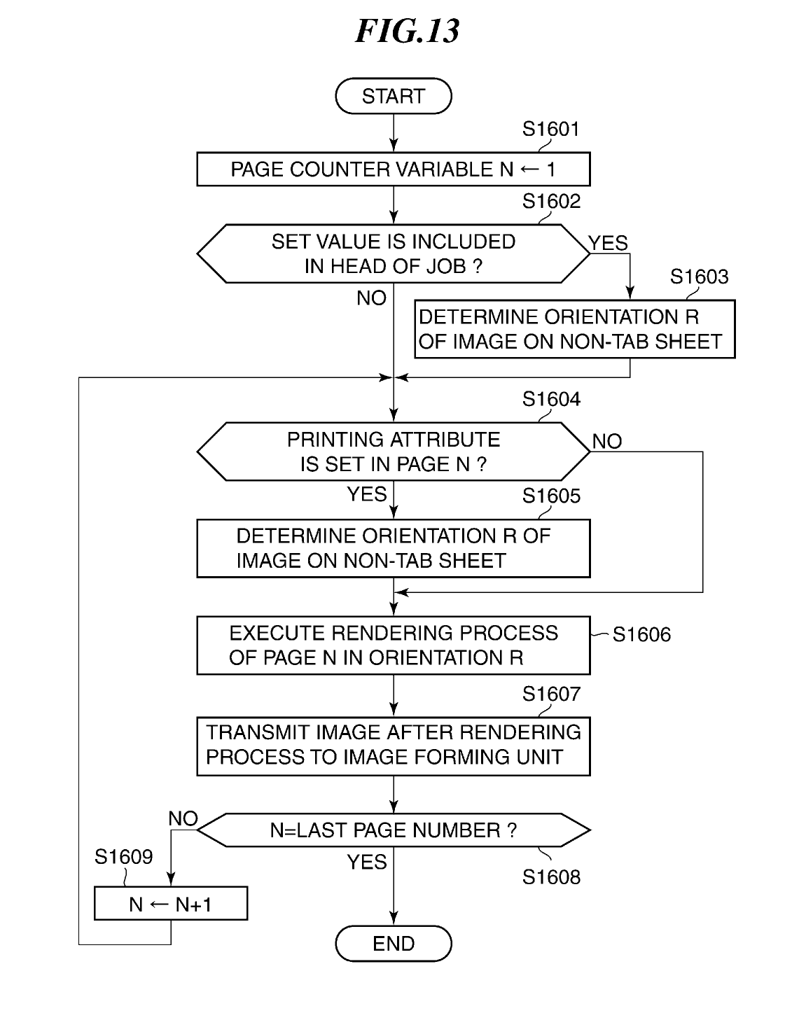

FIG. 13 is a flowchart showing procedures of a process to analyze a received job, to generate image data by the RIP 321, and to transfer the generated image data to the image forming unit 205 to print in the printing apparatus 101 of the second embodiment.

When an analysis process for the received job is started, the CPU 305 initializes a page counter variable N in step S1601 (N←1), and proceeds with the process to step S1602.

In the step S1602, the CPU 305 determines whether a use of a special sheet is set in the information added to the head of the job. In this step, the CPU 305 determines whether the received job is the first format job or the second format job. The CPU 305 functions as the determination unit here.

When the CPU 305 determines that the use of the spatial sheet is set in the information added to the head of the job in the step S1602, i.e., when the CPU 305 determines that the job is the first format job as shown in FIG. 8A, the process proceeds to step S1603. If not, i.e., the CPU 305 determines that the job is the second format job as shown in FIG. 8B, the process proceeds to step S1604.

In the step S1603, the CPU 305 determines an orientation R of an image that will be printed on a non-tab sheet based on a combination of the type of sheet and a post process that are set in the job. The CPU 305 functions as the control unit here. That is, the CPU 305 focuses on the special sheet like the tab sheet of which the conveyance direction is uniquely determined according to the combination with the post process, among the types of the sheets designated in the sheet designation section 1002 of the job. Then, the CPU 305 determines the orientation of the image printed on the special sheet as the orientation R of the image printed on the non-tab sheet. It should be noted that the tab sheet shall be designated as an example of the special sheet in this embodiment.

Next, in step S1604, the CPU 305 determines whether a printing attribute (a designation of the type of sheet, and a designation of a post process or an ejecting destination) is set to the page corresponding to the page counter variable N. When the CPU 305 determines that the printing attribute is not set to the page corresponding to the page counter variable N, the process proceeds to step S1606. On the other hand, when the CPU 305 determines that the printing attribute is set to the page corresponding to the page counter variable N, the process proceeds to step S1605.

In the step S1605, the CPU 305 determines the orientation R of the image to be printed on the non-tab sheet based on the information (the printing attribute) set to the page corresponding to the page counter variable N. The CPU 305 functions as the control unit here.

In the step S1606, the CPU 305 instructs the RIP 321 to perform the RIP process for the image data of the page corresponding to the page counter variable N, generates the image data by executing a rendering process. When generating the image data, the RIP 321 generates the image data so that the image is arranged in the orientation R.

In step S1607, the CPU 305 transmits the image data generated in the step S1606 to the image forming unit 205, and proceeds with the process to step S1608.

In the step S1608, the CPU 305 determines whether the page counter variable N points the last page of the job. When the CPU 305 determines that the page counter variable N points the last page of the job, this process is finished. On the other hand, when it is determined that the page counter variable N does not points the last page of the job, the process proceeds to step S1609.

In the step S1609, the CPU 305 increments the page counter variable N, and proceeds with the process to step S1604 to execute the process in the steps S1604 through S1608 repeatedly.

According to this embodiment, even if the printing apparatus, which is not provided with the mass storage unit, performs the job in which the special sheet (the tab sheet) is mixed with the non-special sheet (the non-tab sheet), images can be printed without generating a mismatch of the orientations of the images among pages. Like the above-mentioned first embodiment, even if a use of the special sheet is set in the middle of a job, it becomes possible to match the orientation of the image on the special sheet with that on the non-special sheet. When a job does not include the special sheet, images can be printed in the same orientation in the same manner as the conventional system.

Next, a third embodiment of the present invention will be described.

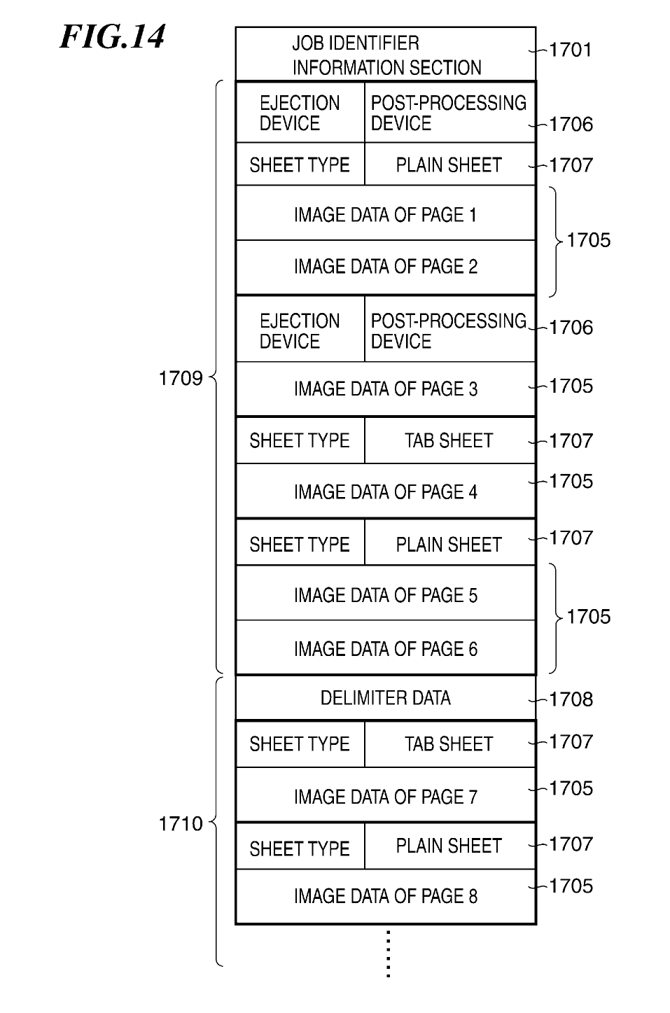

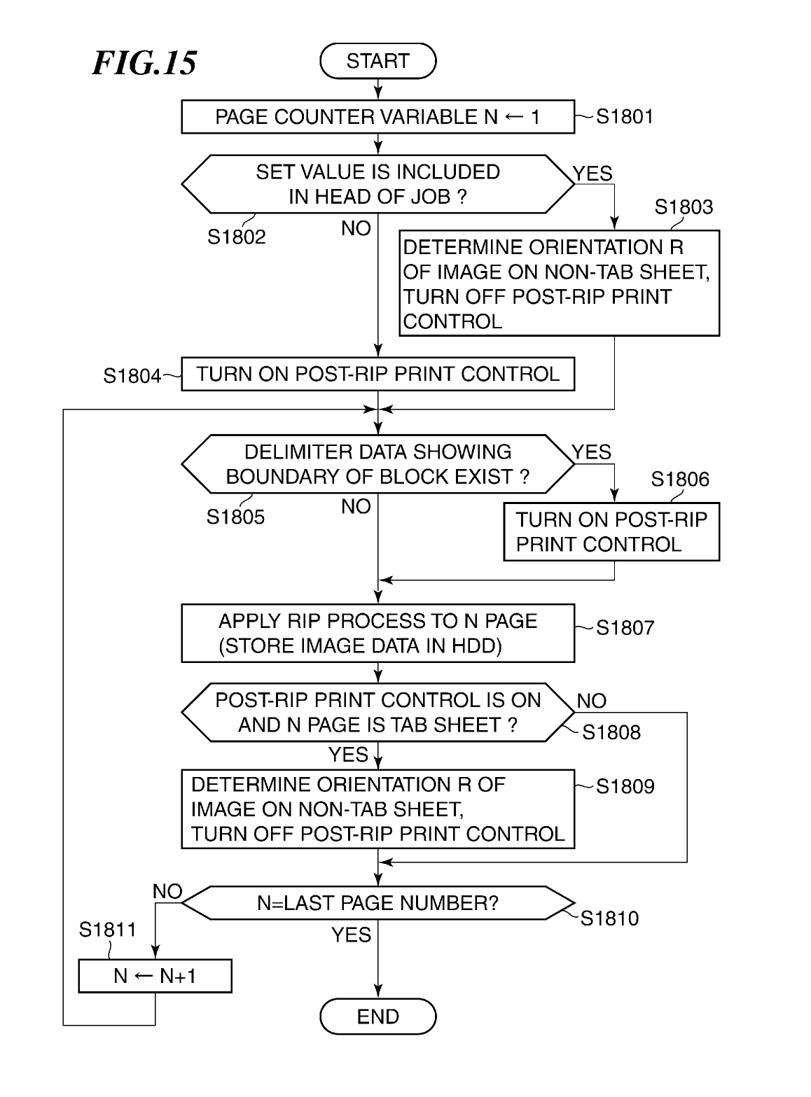

The third embodiment describes the printing process in the printing apparatus 101 when a received job is divided into a plurality of blocks as shown in FIG. 14. The same reference numbers are attached to the same elements as that in the first embodiment, and the duplicated descriptions are omitted.

FIG. 14 is a view showing an example of a data structure of a job that is divided into a plurality of blocks.

The job shown in FIG. 14 includes a job identifier information section 1701 in which a name and ID information of a job are stored, an image data storage section 1705 in which image data is stored per page, an ejecting destination change designation section 1706 in which a change of the ejecting destination is designated, a sheet change designation section 1707 in which a change of the type of printing sheet is designated, and delimiter data 1708 that shows a boundary between blocks in a job. This job comprises a first block 1709 and a second block 1710.

FIG. 15 is a flowchart showing procedures of a process to analyze a received job, to generate image data by the RIP 321, and to store the generated image data to the HDD 311 in the printing apparatus 101 of the third embodiment.

When an analysis process for the received job is started, the CPU 305 initializes a page counter variable N in step S1801 (N←1), and proceeds with the process to step S1802.

In the step S1802, the CPU 305 determines whether a use of a special sheet is set in the information added to the head of the job. In this step, the CPU 305 determines whether the received job is the first format job or the second format job. The CPU 305 functions as the determination unit here.

When the CPU 305 determines that the use of the spatial sheet is set in the information added to the head of the job in the step S1802, i.e., when the CPU 305 determines that the job is the first format job as shown in FIG. 8A, the process proceeds to step S1803. If not, i.e., the CPU 305 determines that the job is the second format job as shown in FIG. 8B, the process proceeds to step S1804.

In the step S1803, the CPU 305 determines an orientation R of an image that will be printed on a non-tab sheet based on a combination of the type of sheet and a post process that are set in the job. The CPU 305 functions as the control unit here. That is, the CPU 305 focuses on the special sheet like the tab sheet of which the conveyance direction is uniquely determined according to the combination with the post process, among the types of the sheets designated in the sheet designation section 1002 of the job. Then, the CPU 305 determines the orientation of the image printed on the special sheet as the orientation of the image printed on the non-tab sheet. It should be noted that the tab sheet shall be designated as an example of the special sheet in this embodiment.

In the step S1803, the CPU 305 turns OFF the post-RIP print control that is a control method of image formation, and proceeds with the process to step S1805.

On the other hand, in the step S1804, the CPU 305 turns ON the post-RIP print control that is a control method of image formation, and proceeds with the process to the step S1805.

In the step S1805, the CPU 305 determines whether there is the delimiter data 1708 that shows a boundary between blocks in the job. The CPU 305 functions as a block determination unit here. When the CPU 305 determines that there is not the delimiter data 1708 that shows a boundary between blocks in the job in the step S1805, the process proceeds to step S1807. On the other hand, when the CPU 305 determines that there is the delimiter data 1708 that shows a boundary between blocks in the job, the process proceeds to step S1806.

In the step S1806, the CPU 305 turns ON the post-RIP print control that is a control of the image formation, and proceeds with the process to the step S1807.

In the step S1807, the CPU 305 instructs the RIP 321 to perform the RIP process for the image data of the page corresponding to the page counter variable N to generate image data, and stores the generated image data in the HDD 311. The CPU 305 and the RIP 321 function as the image data generation unit here.

In step S1808, the CPU 305 determines whether the post-RIP print control is ON and the page of the page counter variable N is the tab sheet. The CPU 305 functions as a sheet determination unit here. When the CPU 305 determines that the post-RIP print control is OFF or the page of the page counter variable N is the non-tab sheet in the step S1808, the process proceeds to step S1810. On the other hand, when the CPU 305 determines that the post-RIP print control is ON and the page of the page counter variable N is the tab sheet, the process proceeds to step S1809.

In the step S1809, the CPU 305 determines the post process or the ejecting destination designated for the page of the page counter variable N, and determines the orientation R of the image to be printed on the non-tab sheet based on the combination with the tab sheet. The CPU 305 functions as the control unit here.

In the step S1810, the CPU 305 determines whether the page counter variable N points the last page of the job. When the CPU 305 determines that the page counter variable N points the last page of the job, this process is finished. On the other hand, when it is determined that the page counter variable N does not points the last page of the job, the process proceeds to step S1811.

In the step S1811, the CPU 305 increments the page counter variable N, and proceeds with the process to step S1805 to execute the process in the steps S1805 through S1810 repeatedly.

It should be noted that the procedures of the process that the image data generated in the step S1807 is transmitted to the image forming unit 205 to print are identical to that shown in FIG. 12 in the above-mentioned first embodiment.

According to this embodiment, even if a job is divided into a plurality of blocks and the special sheet (the tab sheet) is mixed with the non-special sheet (the non-tab sheet) in the job, images can be printed without generating a mismatch of the orientations of the images among pages. Like the above-mentioned first embodiment, even if a use of the special sheet is set in the middle of a job, it becomes possible to match the orientation of the image on the special sheet with that on the non-special sheet. When a job does not include the special sheet, images can be printed in the same orientation in the same manner as the conventional system.

Although the above-mentioned first, second, and third embodiments described the printing system of the combination shown in FIG. 1, the present invention is not restricted to this. The special sheet includes a tab sheet, an index sheet, etc.

Although the steps S1402, S1602, and S1802 of the embodiments mentioned above described the example that determines whether a use of the special sheet is set to the information added to the head of the job, the present invention is not limited to this. For example, it may be determined whether job information showing a setting of a job is added to the head of the job. The job information, which shows a setting of a job, includes tab sheet information that shows whether the special sheet is used during execution of the job concerned, and information that shows the orientation of the special sheet outputted by executing the job. In addition to this, the job information may include the number of pages printed by executing the job, an ejecting destination of a printed sheet, and information about a setting of a post process to the sheet concerned.

Then, when the CPU determines that the job information is added in the step S1402 of the first embodiment, the process proceeds to the S1403. When the CPU determines that the job information is not added, the process proceeds to the step S1404. When the CPU determines that the job information is added in the step S1602 of the second embodiment, the process proceeds to the S1603. When the CPU determines that the job information is not added, the process proceeds to the step S1604. Then, when the CPU determines that the job information is added in the step S1802 of the third embodiment, the process proceeds to the S1803. When the CPU determines that the job information is not added, the process proceeds to the step S1804.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-283239, filed on Dec. 20, 2010, which is hereby incorporated by reference herein in its entirety.

What is claimed is:

1. A printing apparatus that prints an image on a sheet by executing a job comprising:
a determination unit configured to determine whether a use of a tab sheet is set to information added to the head of the job; and
a control unit configured to determine an orientation of an image to be printed on a sheet other than the tab sheet according to an orientation of the tab sheet included in the information when said determination unit determines that the use of the tab sheet is set, and to determine an orientation of an image to be printed on a sheet other than the tab sheet according to discrimination of whether the tab sheet is included in the sheets to be printed by executing the job based on analysis of the job when said determination unit determines that the use of the tab sheet is not set.

2. The printing apparatus according to claim 1, further comprising:
an image data generation unit configured to generate bitmap format image data per page by analyzing the image data included in the job, and to store the generated image data into a storage unit; and
a sheet determination unit configured to determine whether the type of sheet set to each page of the image data stored in the storage unit is a tab sheet,
wherein said control unit determines the orientation of the image printed on a sheet other than the tab sheet based on the information set to each page when said sheet determination unit determines that the type of sheet set to each page is a tab sheet.

3. The printing apparatus according to claim 2, further comprising:
an orientation determination unit configured to determine whether the orientation of the image in each page is the same as the orientation of the image determined by said control unit by analyzing the image data stored in the storage unit per page; and
an image rotation unit configured to rotate the orientation of the image in the page that said orientation determination unit determines as being different from the orientation determined by said control unit, so as to be the same as the orientation determined by said control unit.

4. The printing apparatus according to claim 3, wherein said control unit controls to print all the image data stored in the storage unit on sheets, and said control unit controls to print the image data on a sheet after the orientation of the image is determined.

5. The printing apparatus according to claim 1, further comprising:
a block determination unit configured to determine whether there is a boundary between blocks in the job,
wherein said control unit executes a process per block when said block determination unit determines that there is the boundary between the blocks.

6. The printing apparatus according to claim 1, wherein said control unit determines an orientation of an image to be printed on a sheet other than the tab sheet according to the orientation of the tab sheet included in the information and a setting of a post process when said determination unit determines that the use of the tab sheet is set.

7. A control method for a printing apparatus that prints an image on a sheet by executing a job, the control method comprising:
a determination step of determining whether a use of a tab sheet is set to information added to the head of the job; and
a control step of determining an orientation of an image to be printed on a sheet other than the tab sheet according to an orientation of the tab sheet included in the information when determining that the use of the tab sheet is set in said determination step, and determining an orientation of an image to be printed on a sheet other than the tab sheet according to discrimination of whether the tab sheet is included in the sheets to be printed by executing the job based on analysis of the job when determining that the use of the tab sheet is not set in said determination step.

8. A non-transitory computer-readable storage medium storing a control program causing a computer to execute a control method for a printing apparatus that prints an image on a sheet by executing a job, the control method comprising:
a determination step of determining whether a use of a tab sheet is set to information added to the head of the job; and
a control step of determining an orientation of an image to be printed on a sheet other than the tab sheet according to an orientation of the tab sheet included in the information when determining that the use of the tab sheet is set in said determination step, and determining an orientation of an image to be printed on a sheet other than the tab sheet according to discrimination of whether the tab sheet is included in the sheets to be printed by executing the job based on analysis of the job when determining that the use of the tab sheet is not set in said determination step.

9. A printing apparatus that prints an image on a sheet by executing a job comprising:
a determination unit configured to determine whether job information showing a setting of a job is added to the head of the job; and
a control unit configured to determine an orientation of an image to be printed on a sheet other than the tab sheet according to an orientation of the tab sheet included in the job information when said determination unit determines that the job information is added, and to determine an orientation of an image to be printed on a sheet other than the tab sheet according to discrimination of whether the tab sheet is included in the sheets to be printed by executing the job based on analysis of the job when said determination unit determines that the job information is not added.
